(19) United States
(12) Patent Application Publication
(10) Pub. No.: US 2018/0336469 A1
(43) Pub. Date: Nov. 22, 2018

(54) SIGMA-DELTA POSITION DERIVATIVE NETWORKS

(71) Applicant: QUALCOMM Incorporated, San Diego, CA (US)

(72) Inventors: Peter O'CONNOR, Amsterdam (NL); Max WELLING, Bussum (NL)

(21) Appl. No.: 15/705,161

(22) Filed: Sep. 14, 2017

Related U.S. Application Data
(60) Provisional application No. 62/508,266, filed on May 18, 2017.

(51) Int. Cl. G06N 3/08; G06N 3/04

(52) U.S. Cl. CPC G06N 3/084; G06N 3/04

(57) ABSTRACT

A method for processing temporally redundant data in an artificial neural network (ANN) includes encoding an input signal, received at an initial layer of the ANN, into an encoded signal. The encoded signal comprises the input signal and a rate of change of the input signal. The method also includes quantizing the encoded signal into integer values and computing an activation signal of a neuron in a next layer of the ANN based on the quantized encoded signal. The method further includes computing an activation signal of a neuron at each layer subsequent to the next layer to compute a full forward pass of the ANN. The method also includes back propagating approximated gradients and updating parameters of the ANN based on an approximate derivative of a loss with respect to the activation signal.

### CROSS-REFERENCE TO RELATED APPLICATION

The present application claims the benefit of U.S. Provisional Patent Application No. 62/508,266, filed on May 18, 2017, and titled “SIGMA-DELTA POSITION DERIVATIVE NETWORKS,” the disclosure of which is expressly incorporated by reference herein in its entirety.

### BACKGROUND

### Field

Certain aspects of the present disclosure generally relate to machine learning and, more particularly, to improving systems and methods of learning with temporal data in an artificial neural network.

### Background

An artificial neural network, which may comprise an interconnected group of artificial neurons (e.g., neuron models), is a computational device or represents a method to be performed by a computational device.

The artificial neural network may be specified to perform computations on sequential data, such as a video. The computations may include extracting features and/or classifying objects in the sequential data. The extracted features and/or classification may be used for object tracking. The object tracking may be used for various applications and/or devices, such as internet protocol (IP) cameras, Internet of Things (IoT) devices, autonomous vehicles, and/or service robots. The applications may include improved or more computationally efficient object perception and/or understanding an object's path for planning.

Natural sensory data and other sequential data, such as temporal data (e.g., video), may be temporally redundant. That is, neighboring frames may be similar. For example, video frames or audio samples that are sampled at nearby points in time may have similar values.

In conventional systems, an artificial neural network, such as an artificial neural network used for deep learning, processes each frame of the temporal data with a forward pass of the artificial neural network. For example, a system, such as an artificial neural network, may be tasked with tracking objects in a scene. Conventional systems transmit camera frames to a convolutional network that predicts bounding boxes for tracking objects. Such systems may be trained to predict the location of objects by supervised learning, which consists of training the system on many hours of video with manually annotated bounding boxes. At each iteration, the conventional systems execute a forward pass of a convolutional network. If the frame rate is doubled, the amount of computations of the conventional systems are also doubled, regardless of whether the content of the video is static or substantially static.

As discussed above, conventional systems do not take advantage of the temporal redundancy to improve performance. Processing each frame of the temporal data with a convolutional network may increase the use of resources in a device. That is, the amount of processing resources used in conventional systems is independent of the data content. It is desirable to reduce the number of processing resources by exploiting the similarities of neighboring frames.

### SUMMARY

In one aspect of the present disclosure, a method for processing temporally redundant data in an artificial neural network (ANN) is disclosed. The method includes encoding an input signal, received at an initial layer of the ANN, into an encoded signal. The encoded signal comprises the input signal and a rate of change of the input signal. The method also includes quantizing the encoded signal into integer values. The method further includes computing an activation signal of a neuron in a next layer of the ANN based on the quantized encoded signal. The method still further includes computing an activation signal of a neuron at each layer subsequent to the next layer to compute a full forward pass of the ANN. The activation signal of the neuron at each layer is computed based on quantizing an encoded activation signal at each layer. The method also includes back propagating approximated gradients. The method further includes updating parameters of the ANN based on an approximate derivative of a loss with respect to the activation signal.

Another aspect of the present disclosure is directed to an apparatus including means for encoding an input signal, received at an initial layer of the ANN, into an encoded signal. The encoded signal comprises the input signal and a rate of change of the input signal. The apparatus also includes means for quantizing the encoded signal into integer values. The apparatus further includes means for computing an activation signal of a neuron in a next layer of the ANN based on the quantized encoded signal. The apparatus still further includes means for computing an activation signal of a neuron at each layer subsequent to the next layer to compute a full forward pass of the ANN. The activation signal of the neuron at each layer is computed based on quantizing an encoded activation signal at each layer. The apparatus also includes means for back propagating approximated gradients. The apparatus further includes means for updating parameters of the ANN based on an approximate derivative of a loss with respect to the activation signal.

In another aspect of the present disclosure, a non-transitory computer-readable medium with non-transitory program code recorded thereon is disclosed. The program code is for processing temporally redundant data in an ANN. The program code is executed by a processor and includes program code to encode an input signal, received at an initial layer of the ANN, into an encoded signal. The encoded signal comprises the input signal and a rate of change of the input signal. The program code also includes program code to quantize the encoded signal into integer values. The program code further includes program code to compute an activation signal of a neuron in a next layer of the ANN based on the quantized encoded signal. The program code still further includes program code to compute an activation signal of a neuron at each layer subsequent to the next layer to compute a full forward pass of the ANN. The activation signal of the neuron at each layer is computed based on quantizing an encoded activation signal at each layer. The program code also includes program code to back propagate approximated gradients. The program code further includes program code to update parameters of the ANN based on an approximate derivative of a loss with respect to the activation signal.

Another aspect of the present disclosure is directed to an ANN for processing temporally redundant data, the ANN having a memory unit and one or more processors coupled to the memory unit. The processor(s) is configured to encode an input signal, received at an initial layer of the ANN, into an encoded signal comprising the input signal and a rate of change of the input signal. The processor(s) is also configured to quantize the encoded signal into integer values. The processor(s) is further configured to compute an activation signal of a neuron in a next layer of the ANN based on the quantized encoded signal. The processor(s) still further configured to compute an activation signal of a neuron at each layer subsequent to the next layer to compute a full forward pass of the ANN. The activation signal of the neuron at each layer is computed based on quantizing an encoded activation signal at each layer. The processor(s) is also configured to back propagate approximated gradients. The processor(s) is further configured to update parameters of the ANN based on an approximate derivative of a loss with respect to the activation signal.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC), including a general-purpose processor in accordance with certain aspects of the present disclosure.

FIG. 2 illustrates an example implementation of a system in accordance with aspects of the present disclosure.

FIG. 3A is a diagram illustrating a neural network in accordance with aspects of the present disclosure.

FIG. 3B is a block diagram illustrating an exemplary deep convolutional network (DCN) in accordance with aspects of the present disclosure.

FIG. 4 is a block diagram illustrating an exemplary software architecture that may modularize artificial intelligence (AI) functions in accordance with aspects of the present disclosure.

FIG. 5 is a block diagram illustrating the run-time operation of an AI application on a smartphone in accordance with aspects of the present disclosure.

FIG. 6 illustrates an example of an artificial neural network in accordance with aspects of the present disclosure.

FIG. 7 illustrates a method for processing temporally redundant data in an artificial neural network in accordance with aspects of the present disclosure.

FIG. 8 illustrates a flowchart for processing temporally redundant data in an artificial neural network in accordance with aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### Sigma-Delta Position Derivative Networks

Robotic systems consist of many sensors operating at different frame rates. Some sensors, such as dynamic vision sensors, do not use frames. Rather, these sensors send asynchronous events when a value of a pixel changes beyond a threshold. Conventional systems, such as an artificial neural network used for deep learning, do not integrate asynchronous sensory signals into a unified, trainable, latent representation, without recomputing the function of the network every time a new signal arrives.

It is desirable to increase performance of a neural network (e.g., artificial neural network) by using the temporal redundancies of an input. Aspects of the present disclosure are directed to methods and systems in which neurons can represent their activations as a temporally sparse series of impulses. The impulses from a given neuron encode a combination of the value and the rate of change of the neuron's activation.

That is, to reduce computations, the quantized differences in activations of neurons may be transmitted between layers. In one configuration, each layer communicates a quantized signal for its change in activation to the next layer. If the data is temporally redundant, the changes in activations will be sparse, thereby reducing the number of computations.

Aspects of the present disclosure are designed to improve the use of temporal data rather than learning temporal sequences. That is, in one configuration, the artificial neural network is trained to learn the parameters of a function yₜ=f₍ₓ_{ₜ}₎, where the current target yₜ is a function of the current input xₜ, and not previous inputs x₀ . . . xₜ₋₁. The temporal redundancy between neighboring inputs xₜ₋₁, xₜ, however, may be used to reduce computational resources (e.g., improve the performance of the artificial neural network).

The notation (fₜ◯f₂◯f₃)(x)=f₃ (f₂(f₁(x))) included herein denotes a function composition. Aspects of the present disclosure define various functions, which include an internal state that persists between calls to the function. The functions are defined as:

$$\begin{matrix}Δ \text{:} x \to y ; Persistent \text{:} {x}_{last} ← 0 \\ y ← x - {x}_{last} \\ {x}_{last} ← x & ( 1 ) \\ Σ \text{:} x \to y ; Persistent \text{:} y ← 0 \\ y ← y + x & ( 2 ) \\ Q \text{:} x \to y ; Persistent \text{:} φ ← 0 \\ {φ}^{′} ← φ + x \\ y ← round ( {φ}^{′} ) \\ φ ← {φ}^{′} + y & ( 3 ) \\ enc \text{:} x \to y ; Persistent \text{:} {x}_{last} ← 0 \\ y ← {k}_{p} x + {k}_{d} ( x - {x}_{last} ) \\ {x}_{last} ← x & ( 4 ) \\ dec \text{:} x \to y ; Persistent \text{:} y ← 0 \\ y ← \frac{x + {k}_{d} y}{{k}_{p} + {k}_{d}} & ( 5 ) \\ R \text{:} x \to round ( x ) & ( 6 )\end{matrix}$$

The function Δ of EQUATION 1 returns the difference between the inputs in two consecutive calls, where the persistent variable xₗₐₛₜ is initialized to zero. The function Σ of EQUATION 2 returns a running sum of the inputs over calls. For EQUATIONS 1-5, each function returns a value y based on an input x. EQUATION 6 returns round(x) based on an input x. Persistent variables maintain their state between successive calls of the function. In one configuration, a composition of functions may be called with a sequence of input variables. For example, (Σ◯Δ) may be called with a sequence of input variables x_{T}:t=[1 . . . t], then (Σ◯Δ)(xₜ)=xₜ, because y₀+(x₁−x₀)+(x₂−x₁)+ . . . +(xₜ−xₜ₋₁)|x₀=0, y₀=0=xₜ.

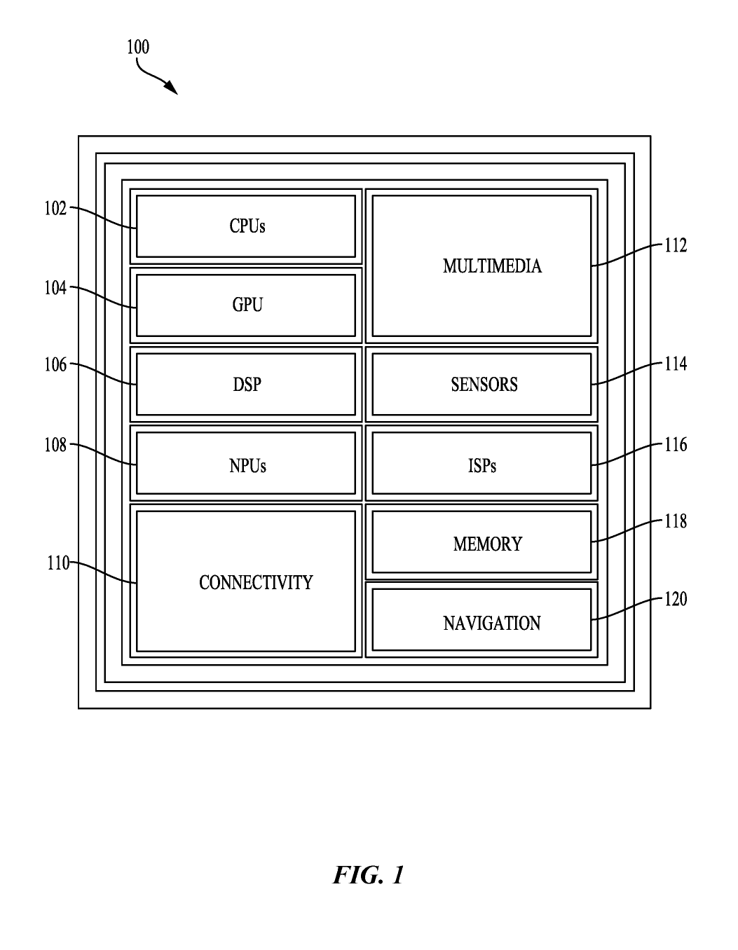

FIG. 1 illustrates an example implementation of the aforementioned method of processing temporally redundant data in an artificial neural network using a system-on-a-chip (SOC) 100, which may include a general-purpose processor (CPU) or multi-core general-purpose processors (CPUs) 102 in accordance with certain aspects of the present disclosure. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a dedicated memory block 118, or may be distributed across multiple blocks. Instructions executed at the general-purpose processor 102 may be loaded from a program memory associated with the CPU 102 or may be loaded from a dedicated memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, unlicensed Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SOC 100 may also include a sensor processor 114, image signal processors (ISPs), and/or navigation 120, which may include a global positioning system.

The SOC 100 may be based on an ARM instruction set. In an aspect of the present disclosure, the instructions loaded into the general-purpose processor 102 may comprise code to encode an input signal into an encoded signal comprising the input signal and a rate of change of the input signal. The instructions loaded into the general-purpose processor 102 may also comprise code to quantize the encoded signal into integer values. In addition, the instructions loaded into the general-purpose processor 102 may comprise code to compute an activation signal of a neuron in a next layer of the artificial neural network based on the quantized encoded signal. The instructions loaded into the general-purpose processor 102 may further comprise code to compute an activation signal of a neuron at each layer subsequent to the next layer to compute a full forward pass of the artificial neural network. The instructions loaded into the general-purpose processor 102 may still further comprise code to back propagate approximated gradients. The instructions loaded into the general-purpose processor 102 may still yet further comprise code to update parameters of the artificial neural network based on an approximate derivative of a loss with respect to the activation signal.

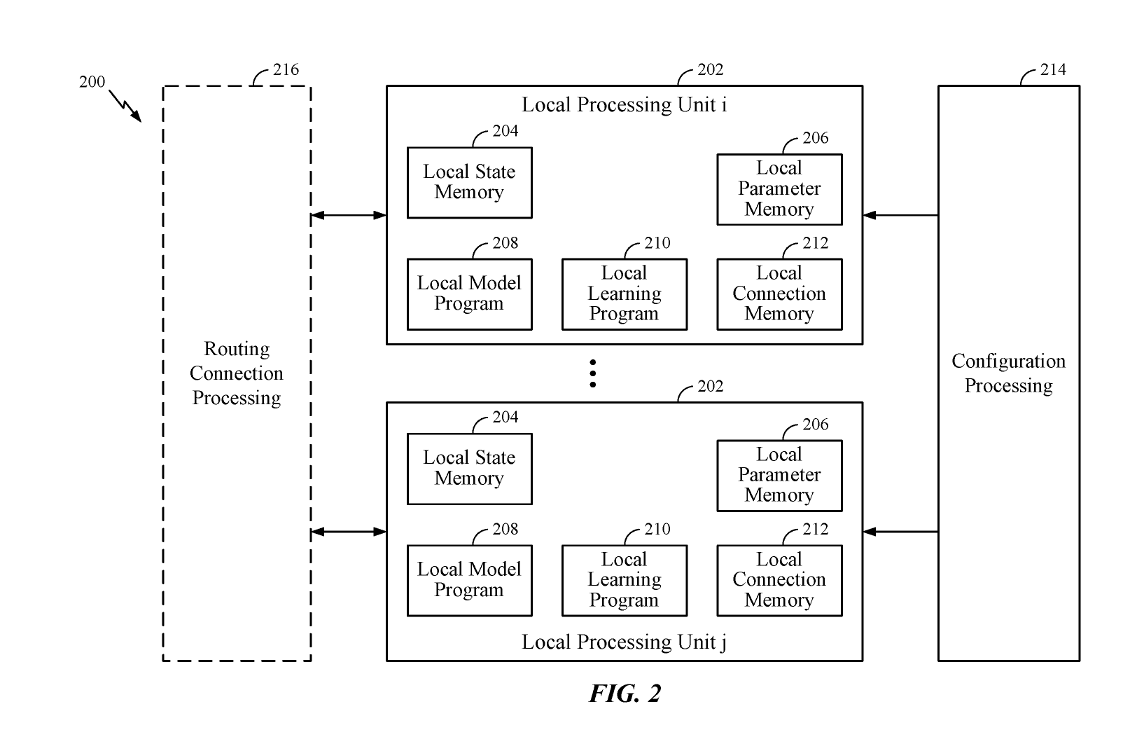

FIG. 2 illustrates an example implementation of a system 200 in accordance with certain aspects of the present disclosure. As illustrated in FIG. 2, the system 200 may have multiple local processing units 202 that may perform various operations of methods described herein. Each local processing unit 202 may comprise a local state memory 204 and a local parameter memory 206 that may store parameters of a neural network. In addition, the local processing unit 202 may have a local (neuron) model program (LMP) memory 208 for storing a local model program, a local learning program (LLP) memory 210 for storing a local learning program, and a local connection memory 212. Furthermore, as illustrated in FIG. 2, each local processing unit 202 may interface with a configuration processor unit 214 for providing configurations for local memories of the local processing unit, and with a routing connection processing unit 216 that provides routing between the local processing units 202.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

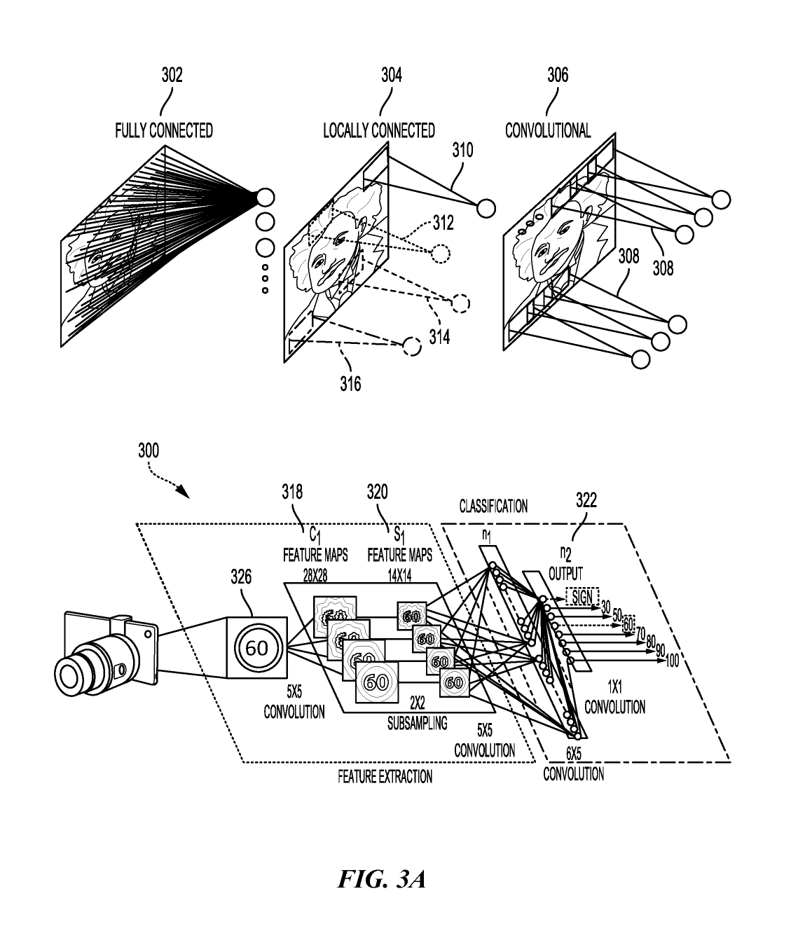

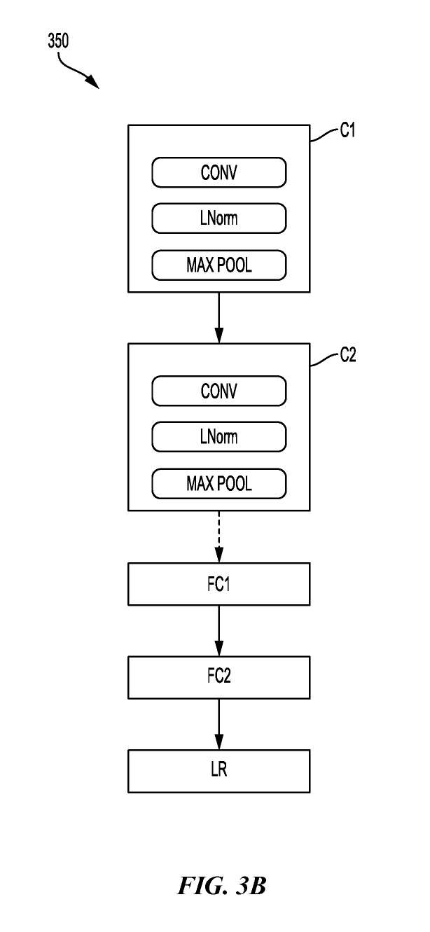

Referring to FIG. 3A, the connections between layers of a neural network may be fully connected 302 or locally connected 304. In a fully connected network 302, a neuron in a first layer may communicate its output to every neuron in a second layer, so that each neuron in the second layer will receive input from every neuron in the first layer. Alternatively, in a locally connected network 304, a neuron in a first layer may be connected to a limited number of neurons in the second layer. A convolutional network 306 may be locally connected, and is further configured such that the connection strengths associated with the inputs for each neuron in the second layer are shared (e.g., 308). More generally, a locally connected layer of a network may be configured so that each neuron in a layer will have the same or a similar connectivity pattern, but with connections strengths that may have different values (e.g., 310, 312, 314, and 316). The locally connected connectivity pattern may give rise to spatially distinct receptive fields in a higher layer, because the higher layer neurons in a given region may receive inputs that are tuned through training to the properties of a restricted portion of the total input to the network.

Locally connected neural networks may be well suited to problems in which the spatial location of inputs is meaningful. For instance, a network 300 designed to recognize visual features from a car-mounted camera may develop high layer neurons with different properties depending on their association with the lower versus the upper portion of the image. Neurons associated with the lower portion of the image may learn to recognize lane markings, for example, while neurons associated with the upper portion of the image may learn to recognize traffic lights, traffic signs, and the like.

A DCN may be trained with supervised learning. During training, a DCN may be presented with an image, such as a cropped image of a speed limit sign 326, and a “forward pass” may then be computed to produce an output 322. The output 322 may be a vector of values corresponding to features such as “sign,” “60,” and “100.” The network designer may want the DCN to output a high score for some of the neurons in the output feature vector, for example the ones corresponding to “sign” and “60” as shown in the output 322 for a network 300 that has been trained. Before training, the output produced by the DCN is likely to be incorrect, and so an error may be calculated between the actual output and the target output. The weights of the DCN may then be adjusted so that the output scores of the DCN are more closely aligned with the target.

To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level.

After learning, the DCN may be presented with new images 326 and a forward pass through the network may yield an output 322 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer 318 and 320, with each element of the feature map (e.g., 320) receiving input from a range of neurons in the previous layer (e.g., 318) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

FIG. 3B is a block diagram illustrating an exemplary deep convolutional network 350. The deep convolutional network 350 may include multiple different types of layers based on connectivity and weight sharing. As shown in FIG. 3B, the exemplary deep convolutional network 350 includes multiple convolution blocks (e.g., C1 and C2). Each of the convolution blocks may be configured with a convolution layer, a normalization layer (LNorm), and a pooling layer. The convolution layers may include one or more convolutional filters, which may be applied to the input data to generate a feature map. Although only two convolution blocks are shown, the present disclosure is not so limiting, and instead, any number of convolutional blocks may be included in the deep convolutional network 350 according to design preference. The normalization layer may be used to normalize the output of the convolution filters. For example, the normalization layer may provide whitening or lateral inhibition. The pooling layer may provide down sampling aggregation over space for local invariance and dimensionality reduction.

The parallel filter banks, for example, of a deep convolutional network may be loaded on a CPU 102 or GPU 104 of an SOC 100, optionally based on an ARM instruction set, to achieve high performance and low power consumption. In alternative embodiments, the parallel filter banks may be loaded on the DSP 106 or an ISP 116 of an SOC 100. In addition, the DCN may access other processing blocks that may be present on the SOC, such as processing blocks dedicated to sensors 114 and navigation 120.

The deep convolutional network 350 may also include one or more fully connected layers (e.g., FC1 and FC2). The deep convolutional network 350 may further include a logistic regression (LR) layer. Between each layer of the deep convolutional network 350 are weights (not shown) that are to be updated. The output of each layer may serve as an input of a succeeding layer in the deep convolutional network 350 to learn hierarchical feature representations from input data (e.g., images, audio, video, sensor data and/or other input data) supplied at the first convolution block C1.

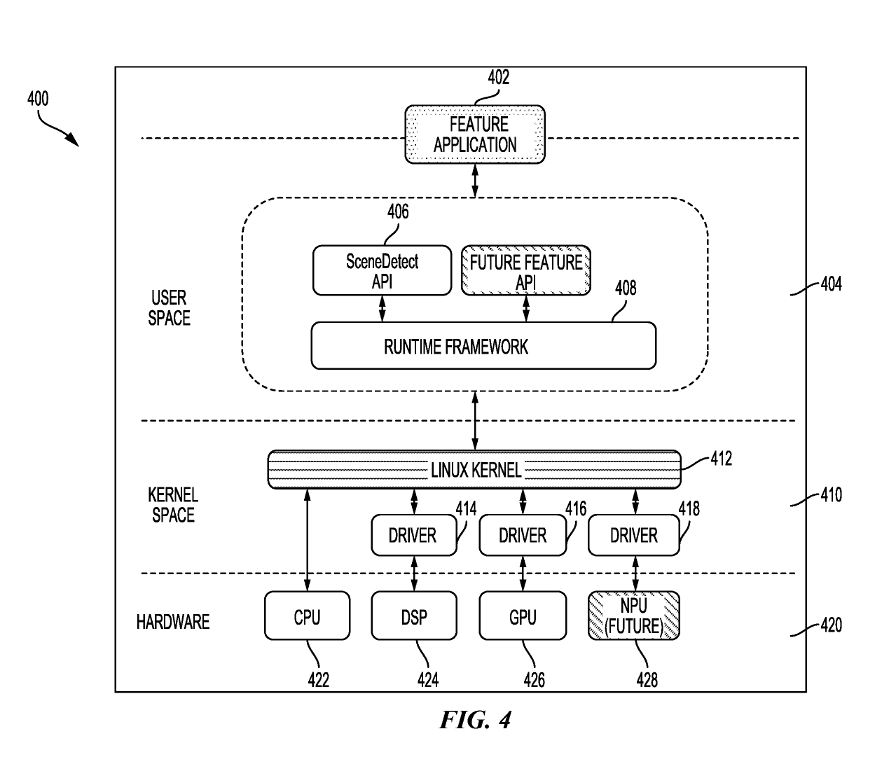

FIG. 4 is a block diagram illustrating an exemplary software architecture 400 that may modularize artificial intelligence (AI) functions. Using the architecture, applications 402 may be designed that may cause various processing blocks of an SOC 420 (for example a CPU 422, a DSP 424, a GPU 426 and/or an NPU 428) to perform supporting computations during run-time operation of the application 402.

The AI application 402 may be configured to call functions defined in a user space 404 that may, for example, provide for the detection and recognition of a scene indicative of the location in which the device currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in a SceneDetect application programming interface (API) 406 to provide an estimate of the current scene. This request may ultimately rely on the output of a deep neural network configured to provide scene estimates based on video and positioning data, for example.

A run-time engine 408, which may be compiled code of a Runtime Framework, may be further accessible to the AI application 402. The AI application 402 may cause the run-time engine, for example, to request a scene estimate at a particular time interval or triggered by an event detected by the user interface of the application. When caused to estimate the scene, the run-time engine may in turn send a signal to an operating system 410, such as a Linux Kernel 412, running on the SOC 420. The operating system 410, in turn, may cause a computation to be performed on the CPU 422, the DSP 424, the GPU 426, the NPU 428, or some combination thereof. The CPU 422 may be accessed directly by the operating system, and other processing blocks may be accessed through a driver, such as a driver 414-418 for a DSP 424, for a GPU 426, or for an NPU 428. In the exemplary example, the deep neural network may be configured to run on a combination of processing blocks, such as a CPU 422 and a GPU 426, or may be run on an NPU 428, if present.

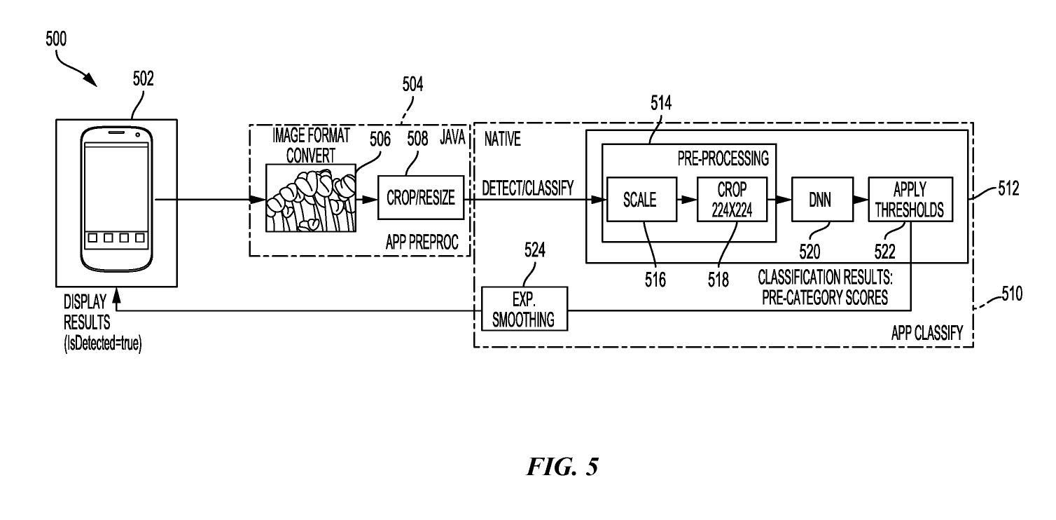

FIG. 5 is a block diagram illustrating the run-time operation 500 of an AI application on a smartphone 502. The AI application may include a pre-process module 504 that may be configured (using for example, the JAVA programming language) to convert the format of an image 506 and then crop and/or resize the image 508. The pre-processed image may then be communicated to a classify application 510 that contains a SceneDetect Backend Engine 512 that may be configured (using for example, the C programming language) to detect and classify scenes based on visual input. The SceneDetect Backend Engine 512 may be configured to further preprocess 514 the image by scaling 516 and cropping 518. For example, the image may be scaled and cropped so that the resulting image is 224 pixels by 224 pixels. These dimensions may map to the input dimensions of a neural network. The neural network may be configured by a deep neural network block 520 to cause various processing blocks of the SOC 100 to further process the image pixels with a deep neural network. The results of the deep neural network may then be thresholded 522 and passed through an exponential smoothing block 524 in the classify application 510. The smoothed results may then cause a change of the settings and/or the display of the smartphone 502.

In one configuration, a machine learning model is configured for encoding an input signal, received at an initial layer of the artificial neural network, into an encoded signal comprising the input signal and a rate of change of the input signal. The model is also configured for quantizing the encoded signal into integer values and for computing an activation signal of a neuron in a next layer of the artificial neural network based on the quantized encoded signal. The model is further configured for computing an activation signal of a neuron at each layer subsequent to the next layer to compute a full forward pass of the artificial neural network. The model is still further configured for back propagating approximated gradients. The model is also configured for updating parameters of the artificial neural network based on an approximate derivative of a loss with respect to the activation signal.

The model includes encoding means, quantizing means, computing means, back propagating means and/or updating means. In one aspect, the encoding means, quantizing means, computing means, back propagating means and/or updating means may be the general-purpose processor 102, program memory associated with the general-purpose processor 102, memory block 118, local processing units 202, and or the routing connection processing units 216 configured to perform the functions recited. In another configuration, the aforementioned means may be any module or any apparatus configured to perform the functions recited by the aforementioned means.

According to certain aspects of the present disclosure, each local processing unit 202 may be configured to determine parameters of the model based upon desired one or more functional features of the model, and develop the one or more functional features towards the desired functional features as the determined parameters are further adapted, tuned and updated.

If a neuron has a time-varying activation xₜ:τ∈[1 . . . t], similar to proportional-integral-derivative (PID) controllers, the activation (e.g., signal) received at a layer of an artificial neural network may be encoded at each time step as a combination of its current activation and change in action (e.g., rate of change in time):

αₜ [symbol] enc(xₜ₎₌kₚxₜ+k_{d}(xₜ−xₜ₋₁) (7)

The parameters kₚ (position component) and k_{d} (difference component) determine what portion of the encoded signal represents the signal (e.g., value of the neuron) and the rate of change of the signal (e.g., change in value), respectively.

The encoded signal may be decoded by solving for the time-varying activation xₜ:

$${x}_{t} = \frac{{a}_{t} + {k}_{d} {x}_{t} - 1}{{k}_{p} + {k}_{d}} = \frac{1}{{k}_{d}} {\sum }_{τ = 0}^{t - 1} {( \frac{{k}_{d}}{{k}_{p} + {k}_{d}} )}^{τ + 1} {x}_{t - τ} \qquad ( 8 )$$

From the encoding scheme (EQUATION 4), a decoding scheme may be derived such that (dec◯enc)(xₜ)=xₜ. In one configuration, the decoding from EQUATION 5 corresponds to decaying the previous decoder state by a constant

$$\frac{{k}_{d}}{{k}_{p} + {k}_{d}}$$

and adding the input

$$\frac{{a}_{t}}{{k}_{d} + {k}_{p}} .$$

The aforementioned scheme may be recursively expanded to correspond to taking a temporal convolution of the signal 60 *k, where k is a causal exponential kernel and T is a time index, given by:

$${k}_{T} = \{ \frac{1}{{k}_{d}} {( \frac{{k}_{d}}{{k}_{d} + {k}_{p}} )}^{T + 1} if T \geq 0 ; otherwise 0 \} . \qquad ( 9 )$$

The encoded signal may be quantized into a representation, such as a sparse representation. In doing so, the number of computations performed may be reduced. A Sigma-Delta modulation may be applied to the encoded signal αₜ to create a sparse integer signal sₜ, which can be used to approximately reconstruct the original signal xₜ. That is, sₜ [symbol] Q(αₜ), where Q is defined in EQUATION 3. Sigma-Delta modulation may be used to communicate signals at low bit-rates. The sparse integer signal sₜ may be an input to a weight-matrix w that communicates the signal to a next layer of the neural network. The sparse integer signal sₜ may also be referred to as a quantized signal.

In one configuration, Q(xₜ)=(Δ◯R◯Σ)(xₜ), where Δ◯R◯Σ indicates applying a temporal summation, a rounding, and a temporal difference, respectively. When |αₜ|<<1∀t (e.g., the data is temporally redundant), the sparse integer signal sₜ may be comprised of mostly zeros with a few 1's and −1's. That is, the integer signal sₜ may be sparse when the data is temporally redundant. If the integer signal sₜ is sparse, the number of multiplications performed with the weight-matrix may be reduced, thereby reducing computations of the neural network. The product of the sparse integer signal sₜ and weight-matrix wₜ may be decoded at a next layer to obtain activations \hat{z}ₜ for neurons of the next layer.

The original input signal xₜ may be approximately reconstructed as \hat{x}ₜ [symbol] dec(sₜ) by applying the decoder (EQUATION 5), where dec represents a decoding scheme. As the coefficients kₚ, k_{d} increase, the difference between the reconstructed signal \hat{x}ₜ and the original input signal xₜ should decrease. According to aspects of the present disclosure, the input signal xₜ is a signal received at an initial layer of a neural network. An activation signal zₜ may be a pre-nonlinearity activation for layers after the initial layer (e.g., hidden layers) of the neural network.

The reconstruction function may also be written as \hat{x}=(dec◯Δ◯R◯Σ◯enc)(xₜ). When kₚ equals zero, dec(xₜ)=(k_{d}⁻¹◯Σ)(xₜ) and enc(xₜ)=(k_{d}◯Δ)(xₜ), such that the reconstruction is reduced to \hat{x}=(k_{d}⁻¹◯Σ◯Δ◯R◯Σ◯k_{d}◯Δ)(xₜ). Σ◯k_{d}◯Δ A commute with each other. Thus, the reconstruction may be further simplified to \hat{x}=(k_{d}⁻¹◯R◯k_{d})(xₜ) and the encoding-decoding process simplifies to \hat{x}ₜ=round(xₜ·k_{d})/k_{d}, with no dependence on xₜ₋₁. When k_{d} equals zero, dec(xₜ)=kₚ⁻¹xₜ and enc(xₜ)=kₚxₜ. Thus, in this configuration, the encoding-decoding process is \hat{x}=(kₚ⁻¹◯Δ◯R◯Σ◯kₚ)(xₜ). In this configuration (e.g., when k_{d} equals zero), the encoder and decoder do not use a memory unit.

The quantization scheme reduces an amount of computations performed by a neural network by sparsifying communication between layers of a neural network. For example, the system may be tasked with computing a pre-nonlinearity activation of a first hidden layer, zₜ∈ [symbol] ^{d}^{ₒᵤₜ}, given an input activation, xₜϵ [symbol] ^{d}^{ᵢₙ}. The signal zₜ (e.g., pre-nonlinearity activation) may be approximated as:

zₜ [symbol] xₜ·wₜ≈\hat{x}ₜ·wₜ [symbol] dec(Q(enc(xₜ)))·wₜ [symbol] dec(sₜ)·wₜ≈dec(sₜ·wₜ) [symbol] \hat{z}ₜ (10)

where xₜ, \hat{x}ₜϵ [symbol] ^{d}^{ᵢₙ}; sₜϵ [symbol] ^{d}^{ᵢₙ}; wϵ [symbol] ^{d}^{ᵢₙ}^{×d}^{ₒᵤₜ}; zₜ, \hat{z}ₜϵ [symbol] ^{d}^{ₒᵤₜ}

In EQUATION 10, dᵢₙ is a dimension of an input, dₒᵤₜ is a dimension of the output, [symbol] ^{d}^{ᵢₙ} is a real vector size of dᵢₙ, [symbol] ^{d}^{ᵢₙ} in is an integer vector of size dᵢₙ, and [symbol] ^{d}^{ₒᵤₜ} is a real vector size of dₒᵤₜ. The first approximation comes from the quantization (Q) of the encoded signal, and the second from change of the weights over time. During training, weights change over time. Therefore, only sending the changes in activations (e.g., kₚ equals zero) may result in an error. In accordance with aspects of the present disclosure, zₜ is approximated with \hat{z}ₜ. As the weight changes over time, the estimate \hat{z} diverges from the correct value. Introducing kₚ causes the reconstruction to be similar to the correct signal.

Computing the activation signal zₜ may take dᵢₙ·dₒᵤₜ multiplications and (dᵢₙ−1)·dₒᵤₜ additions. Additionally, computing \hat{z}ₜ depends on the content of sₜ. If the data is temporally redundant, sₜϵ [symbol] ^{d}^{ᵢₙ} may be sparse. A total magnitude S [symbol] Σᵢ|s_{t,i}|·sₜ may be decomposed into a sum of one-hot vectors sₜ=Σₙ₌₁^{S}sign(s_{t,i}_{ₙ})eᵢ_{ₙ}:iₙϵ[1 . . . dᵢₙ], where eᵢ_{ₙ}ϵ [symbol] ^{d}^{ᵢₙ} is a one-hot vector with element eᵢ_{ₙ}=1, and iₙ is the index of the unit having the n^{th} neural activity (e.g., spike). The matrix product sₜ·w (e.g., the product of the sparse activations (sₜ) and the weight-matrix (w) may be decomposed into a series of row additions:

sₜ·w=(Σₙ₌₁^{N}sign(s_{t,i}_{ₙ})·eᵢ_{ₙ})·w=Σₙ₌₁^{N}sign(s_{t,i}_{ₙ})·w=Σₙ₌₁^{N}sign(s_{t,i}_{ₙ})·wₙ (11)

By including encoding, quantization, and decoding operations, the matrix product takes 2dᵢₙ·2dₒᵤₜ multiplications and Σₙ|s_{t,i}|·dₒᵤₜ+3dᵢₙ+dₒᵤₜ additions. Thus, the relative cost of computing \hat{z}ₜ in view of zₜ is:

$$\frac{cost ( \hat{z} )}{cost ( z )} \approx \frac{{\sum }_{n} \vert {s}_{t , i} \vert \cdot cost ( add )}{{d}_{in} \cdot ( cost ( add ) + cost ( mult ) )} \qquad ( 12 )$$

The encoding scheme may be implemented on layers of a neural network. In one configuration, the encoding scheme is implemented on every layer of the neural network. That is, the encoding scheme may be implemented for every layer of the neural network for a forward pass and a backward pass. Given a standard neural network fₙₙ including alternating linear (·wₗ) and nonlinear (hₗ) operations, the network function (e.g., approximating activations for each layer of the neural network during a forward pass) for a position derivative neural network f_{pdnn} may be expressed as:

fₙₙ(x)=(h_{L}◯·w_{L}◯ . . . ◯h₁◯w₁)(x) (13)

f_{pdnn}(x)=(h_{L}◯w_{L}◯Q_{L}◯enc_{L}◯ . . . ◯h₁◯dec₁◯·w₁◯Q₁◯enc₁)(x) (14)

where the network f_{pdnn} should not be interpreted as a true function, because it has a state encoded in the Q, enc, and dec modules that is updated with each new input.

The same or similar approach may be used for approximately calculating gradients to use in training. The layer activations may be defined as \hat{z}ₗ [symbol] (dec◯·wₗ◯Q◯enc(x) l=1; otherwise (dec◯·wₗ◯Q◯enc)(\hat{z}ₗ−1), and [symbol] [symbol] l(f_{pdnn}(x),y), where l is a loss function and y is a target. Accordingly, the network may be updated by back propagating the approximated gradients as follows:

$$\frac{{\partial }_{{\hat{z}}_{l}}}{} \{ \begin{matrix}\frac{\partial ℒ}{\partial {z}_{ℒ}} & if l = L \\ ( ⊙ {h}_{i}^{′} ( {\hat{z}}_{l} ) • dec • \cdot {w}_{l + 1}^{T} • Q • enc ) ( \frac{{\partial }_{{\hat{z}}_{l + 1}}}{} ) & otherwise .\end{matrix} \qquad ( 15 )$$

where zₗ is the activation of layer l, ∂ [symbol] is the derivative of the loss,

$$\frac{\partial ℒ}{\partial {z}_{ℒ}}$$

is the derivative of the loss with respect to the activation (e.g., error signal), hₗ is the activation function of layer l, h′ₗ represents a derivative of an activation function of a layer l, L is an index of a final layer, and

$$\frac{{\partial }_{{\hat{z}}_{l}}}{}$$

an approximation of the derivative of the loss with respect to the activation. That is, a loss [symbol] is obtained after the last layer of the neural network. The loss for a layer above the current layer (l+1) is propagated back to the current layer (l). Specifically, at the layer above the current layer (l+1), the loss [symbol] (e.g., gradient with respect to the loss) is encoded enc, quantized Q. The quantized gradient is transmitted to the current layer (l) to be multiplied by a weight matrix wₗ₊₁^{T}, where T is a matrix transpose operator, decoded dec and multiplied by the derivative of the activation function ⊙h′ₗ(\hat{z}ₗ). The back propagation continues for all layers of the neural network.

In a neural network trained with back propagation and stochastic gradient descent, the parameter update for the weight matrix w has the form

$$w ← w - η \frac{\partial ℒ}{\partial w} ,$$

where η is the learning rate. If w connects layer l−1 to layer l,

$$\frac{\partial ℒ}{\partial w}$$

may be written as

$$\frac{\partial ℒ}{\partial w}$$

=xₜ⊗eₜ, where xₜ [symbol] hₗ₋₁(z_{l-1,t})ϵ [symbol] ^{d}^{ᵢₙ} is the presynaptic activation,

$${e}_{t} {=}^{Δ} \frac{\partial ℒ}{\partial {z}_{l , t}} ϵ {ℝ}^{{d}_{out}}$$

is the postsynaptic activation, ⊗ is the outer product, and ∂w is the derivative of the loss with respect to the weight matrix.

After back propagating the approximated gradients, the parameters of the neural network may be updated. The parameters comprise weights and biases in a model of the artificial neural network. Updating the parameters for each sample may take dᵢₙ·dₒᵤₜ multiplications. The sparsity of the encoded signals may improve the computation of the product (e.g., reduce computation time). In one configuration, the encoding-quantizing-decoding scheme may be applied to input and error signals as x̅ₜ [symbol] (Q◯enc)(xₜ)ϵ [symbol] ^{d}^{ᵢₙ} and ēₜ [symbol] (Q◯enc)(eₜ)ϵ [symbol] ^{d}^{ₒᵤₜ}. The true update may be approximated as

$$\frac{{\partial }_{{w}_{recon , t}}}{} {=}^{Δ} {\hat{x}}_{t} ⊗ {\hat{e}}_{t} , \\ where {\hat{x}}_{t} {=}^{Δ} dec ( {\overline{x}}_{t} ) and {\hat{e}}_{t} {=}^{Δ} dec ( {\overline{e}}_{t} ) .$$

The sum of the value may be computed over time using an update scheme, such as a past update or a future update scheme. \hat{x}ₜ and êₜ are reconstructions of the quantized input signal x̅ and the quantized error signal ē.

A synapse may have a weight w (e.g., weight matrix) from a first neuron i to a second neuron j. Such that the strength of a synapse from the first neuron i to the second neuron j is represented as w_{i,j}. In a past update scheme, given a weight of synapse w_{i,j}, if either the presynaptic neuron spikes (x̅ₜ_{ᵢ}≠0) or the postsynaptic neuron spikes (ēₜ_{ᵢ}≠0), the weight of the synapse w_{i,j} is incremented by the total area under \hat{x}_{T,i}ê_{T,j} since the last spike. A geometric sequence may be present between the current time and the time of the previous spike \hat{x}_{T,i}ê_{T,j}. Given a known initial value u, final value v, and decay rate r, a geometric sequence sums to

$$\frac{u - v}{1 - r} .$$

The past updates may be calculated as follows:

$$past \text{:} ( {\overline{x}}_{i} ∈ , {\overline{e}}_{j} ∈ ) \to {w}_{i , j} \\ Persistent \text{:} {w}_{i , j} , {u}_{i , j} ∈ {ℝ}^{{d}_{in} , {d}_{out}} , \\ {x}_{r} ← {0}^{{d}_{in}} , {e}_{r} ← {0}^{{d}_{out}} \\ i = \overline{x} \neq 0 \\ j = \overline{e} \neq 0 \\ \hat{x} ← {k}_{α} \hat{x} \\ \hat{e} ← {k}_{α} \hat{e} \\ v ← {\hat{x}}_{i} ⊗ {\hat{e}}_{j} \\ {w}_{i , j} ← {w}_{i , j} - \frac{η}{{k}_{α}^{2} - 1} ( v - {u}_{i , j} ) \\ \hat{x} ← \hat{x} + {k}_{β} \hat{x} \\ \hat{e} ← \hat{e} + {k}_{β} \hat{e} \\ {u}_{i , j} ← v \qquad ( 16 )$$

In another configuration, for a future updates scheme, the present value of the future area under the integral from the current spike is calculated. The future updates may be calculated as follows:

$$f uture \text{:} ( {\overline{x}}_{i} ∈ , {\overline{e}}_{j} ∈ ) \to {w}_{i , j} \\ Persistent \text{:} {w}_{i , j} ∈ {ℝ}^{{d}_{in} , {d}_{out}} , \\ \hat{x} ← {0}^{{d}_{in}} , \hat{e} ← {0}^{{d}_{out}} \\ \hat{x} ← {k}_{α} \hat{x} \\ \hat{e} ← {k}_{α} \hat{e} + \hat{x} + {k}_{β} \overline{e} \\ {w}_{i , j} ← {w}_{i , j} - \frac{η}{{k}_{α}^{2} - 1} ( {\overline{x}}^{T} \cdot {e}_{r} + {x}_{r}^{T} \cdot \overline{e} ) \\ \hat{x} ← \hat{x} + {k}_{β} \overline{x} \qquad ( 17 )$$

For the update schemes, the coefficients kₚ, k_{d} may be re-parametrized as

$${k}_{α} {=}^{Δ} = \frac{{k}_{d}}{{k}_{p} + {k}_{d}} , {k}_{β} {=}^{Δ} = \frac{1}{{k}_{p} + {k}_{d}} ,$$

where k_{α} and k_{β} are real numbers. The updates may be rephrased as a spike-timing dependent plasticity (STDP) rule. In one configuration, the quantized input signal is defined as x̅ₜ [symbol] (Q◯enc)(xₜ), the error signal is defined as ēₜ [symbol] (Q◯enc)(eₜ), and the reconstructed signals are defined as \hat{x}ₜ [symbol] dec(x̅ₜ) and êₜ [symbol] dec(ēₜ). Using the reconstructions \hat{x}ₜ and êₜ of the quantized input signal x̅ and the error signal ē, a causal convolutional kernel may be defined:

kₜ={k_{β}(k_{α})^{t} if t≥0 otherwise 0} and

gₜ={kₜ if t≥0 otherwise k₋ₜ}=k_{β}(k_{α})^{|t|} (18)

where tϵI. The spike-timing dependent plasticity (STDP) update rule may be defined as:

$$\frac{{\partial }_{{w}_{t , STDP}}}{} = ( {\sum }_{T = - ∞}^{∞} {\overline{x}}_{t - {T}_{g} T} ) ⊗ {\overline{e}}_{t} \qquad ( 19 )$$

As shown in EQUATION 19, in contrast to conventional STDP, according to aspects of the present disclosure, a sign of the weight change does not depend on whether the presynaptic spike preceded the postsynaptic spike.

The quality of a reconstructed signal may depend on the signal magnitude. During training, the error gradients tend to change in magnitude throughout the training (e.g., a value of the error gradients decreases as the network learns). To maintain the signal within a dynamic range of the quantizer, kₚ and k_{d} are heuristically adjusted for the forward pass and backward pass separately, for each layer of the neural network. Instead of directly setting kₚ, k_{d} as hyperparameters, the ratio

$${k}_{α} {=}^{Δ} = \frac{{k}_{d}}{{k}_{p} + {k}_{d}}$$

is fixed and the scale

$${k}_{β} {=}^{Δ} = \frac{1}{{k}_{p} + {k}_{d}}$$

is adapted to the magnitude of the signal. The update rule for k_{β} is:

μₜ=(1−ηₖ)μₜ₋₁+ηₖ·|xₜ|L₁

k_{β}=k_{β}ηₖ(k_{β}^{rel}·μₜ−k_{β}) (20)

where ηₖ is the scale-adaptation learning rate, μₜ is a rolling average of the L₁ magnitude of signal xₜ, and k_{β}^{rel} defines how coarse the quantization should be relative to the signal magnitude. A greater value for k_{β}^{rel} reflects a greater coarse value. kₚ, k_{d} may be recovered for use in the encoders and decoders as kₚ=(1−k_{α})/k_{β} and k_{d}=k_{α}/k_{β}.

Aspects of the present disclosure are directed to reducing an amount of computations performed in artificial neural networks, such as deep neural networks, by taking advantage of temporal redundancy in data. In one configuration, the communications between layers of a neural network are sparsified (EQUATION 4) by having neurons of the artificial neural network communicate a combination of their temporal change in an activation and the current value of their activation. Based on the scheme to sparsify communications, neurons should behave as leaky integrators (EQUATION 5). When neural activations are quantized with Sigma-Delta modulation, the neuron is substantially similar to a leaky integrate-and-fire neuron. Furthermore, aspects of the present disclosure derive update rules for the weights of the artificial neural network. As discussed above, the update rules are similar to a form of STDP. Finally, aspects of the present disclosure train artificial neural networks.

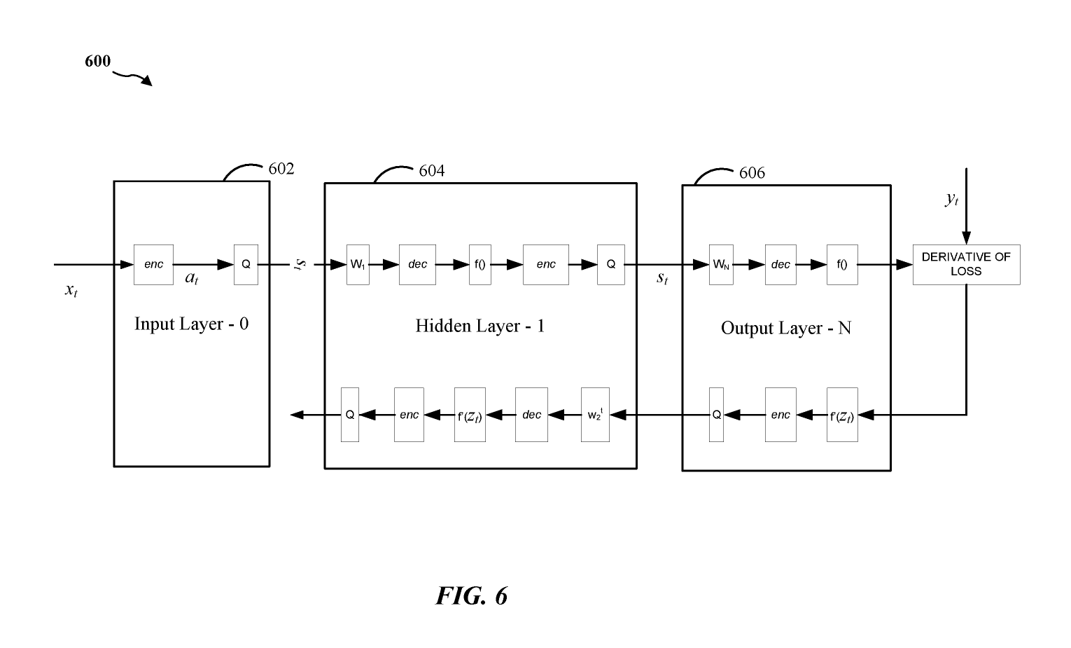

FIG. 6 illustrates an example of an artificial neural network 600 according to aspects of the present disclosure. As shown in FIG. 6, the artificial neural network 600 includes multiple layers (0, 1, . . . N) (e.g., initial layer (0) 602, hidden layer (1) 604, and output layer (N) 606). Each layer 602, 604, and 606 may include one or more neurons. Of course, aspects of the present disclosure are not limited to a three layer system and any number of layers are contemplated.

In this example, the initial layer 602 receives an initial signal xₜ (e.g., original signal) at a time step t. The initial signal xₜ may be encoded with an encoding function (enc) to obtain an encoded signal αₜ (see EQUATION 7). In one configuration, Sigma-Delta modulation is applied to the encoded signal αₜ to create an integer signal sₜ(e.g., quantized signal sₜ [symbol] Q(αₜ)). Furthermore, the initial layer transmits the quantized signal sₜ to a hidden layer 604.

The hidden layer 604 (e.g., layer 2) applies a weight matrix wₜ (e.g., w₁) to the quantized signal sₜ and decodes (dec) the product of the quantized signal sₜ and a weight matrix wₜ to approximate an activation signal \hat{z}ₜ. In one configuration, a nonlinearity function f( ) is applied to the decoded signal. The nonlinearity is used to map the input to the output. Furthermore, as shown in FIG. 6, the decoded signal may be encoded (enc) and quantized before being transmitted to the output layer 606. In one configuration, the process is repeated for all of the layers of the artificial neural network 600 to compute a forward pass.

Furthermore, as shown in FIG. 6, after the output layer 606 (e.g., layer N) of the artificial neural network 600, a loss L is obtained based on a target yₜ. After the last layer 606, a derivative of the loss with respect to the activations (e.g., output layer activations) is determined. A derivative of the nonlinearity f′( ) evaluated at the pre-nonlinearity activation zₜ (e.g., f′(zₜ)) is applied to the derivative of the loss with respect to the activations (e.g., gradient with respect to the loss). The derivative of the loss with respect to the activations is then encoded (enc), quantized Q, and transmitted to a previous layer (e.g., hidden layer 604). At the hidden layer, the quantized derivative of the loss (e.g., quantized derivative with respect to the loss) is multiplied by a weight matrix wₗ₊₁^{T} (e.g., w₂^{T}), decoded dec, and multiplied by the derivative of the activation function ⊙h′ₗ(\hat{z}ₗ) to approximate a loss. The process is repeated for all of the layers of the artificial neural network 600 to back propagate approximated gradients.

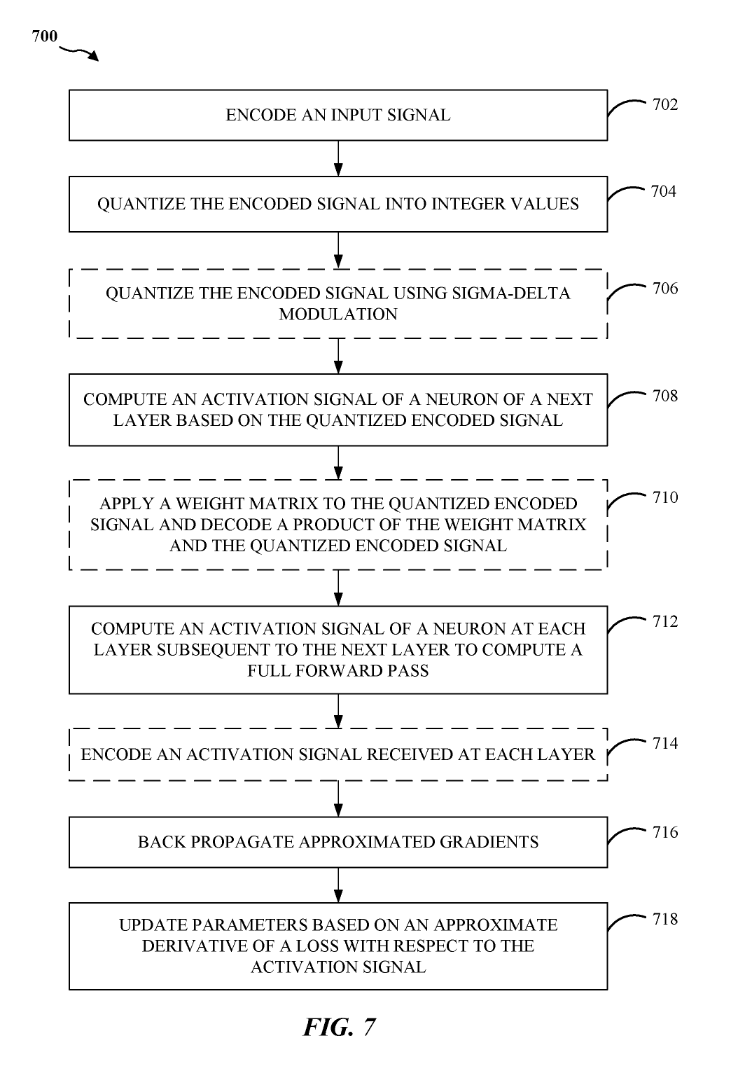

FIG. 7 illustrates a method 700 for processing temporally redundant data in an artificial neural network in accordance with aspects of the present disclosure. At block 702, the artificial neural network encodes an input signal received at an initial layer of the artificial neural network. The signal may be an activation signal and the signal may be encoded at each time step t as a combination of a current activation kₚ and change in action (e.g., rate of change in time) k_{d}. In one configuration, an initial signal xₜ (e.g., original signal) at a time step t is encoded with the encoding function (enc) of EQUATION 4 to obtain an encoded signal αₜ (see EQUATION 7).

At block 704, the artificial neural network quantizes the encoded signal into integer values (e.g., integer signal). In an optional configuration, at block 706, the encoded signal is quantized using Sigma-Delta modulation. That is, in this configuration, Sigma-Delta modulation is applied to the encoded signal αₜ to create an integer signal sₜ, which can be used to approximately reconstruct the initial signal xₜ. The quantization may be performed by the quantization function Q of EQUATION 3. When the data is temporally redundant, the integer is a sparse integer signal comprised of mostly zeros with a few ones and negative ones. The sparse integer signal may be a sparse vector including the integer values.

At block 708, the artificial neural network computes an activation signal of a neuron of a next layer (e.g., layer after the initial layer) based on the quantized encoded signal. In an optional configuration, at block 710, the artificial neural network applies a weight matrix to the quantized encoded signal and decodes a product of the weight matrix and the quantized encoded signal to compute the activation signal. That is, the activation signal \hat{z}ₜ is approximated by decoding the product of the sparse integer signal sₜ (e.g., quantized signal) and a weight matrix wₜ. The process for computing the activation signal may be performed according to EQUATION 10. The weights of the weight matrix may comprise real values. Further, the weights of the weight matrix may also vary or change over time.

At block 712, the artificial neural network computes an activation signal of a neuron at each layer subsequent to the next layer to compute a full forward pass of the artificial neural network. In an optional configuration, at block 714, the artificial neural network encodes an activation signal received at each layer. That is, the artificial neural network repeats a process for computing an activation signal of a neuron for each layer of the neural network to compute a full forward pass of the neural network. The activation signal of the neuron at each layer is computed based on quantizing an encoded activation signal at each layer. Specifically, for a forward pass, the artificial neural network encodes a signal (e.g., input signal at an initial layer and activation signal at subsequent layers), quantizes the encoded signal, and computes an activation signal. The process for a forward pass (e.g., approximating activations for each layer of the neural network during a forward pass) may be performed according to EQUATION 14.

At block 716, the artificial neural network back propagates approximated gradients. That is, after completing the forward pass, a loss [symbol] is obtained after the last layer of the neural network. The derivative of the loss with respect to output layer activations for a layer above the current layer (l+1) is propagated back to the current layer (l). Specifically, at the layer above the current layer (l+1), the derivative of the loss with respect to output layer activations (e.g., gradient with respect to the loss) is encoded enc and quantized Q. The quantized gradient is transmitted to the current layer (l) to be multiplied by a weight matrix wₗ₊₁^{T}, decoded dec, and multiplied by the derivative of the activation function ⊙h′ₗ(\hat{z}ₗ). The back propagation continues for all layers of the neural network. The process for back propagating approximated gradients may be performed according to EQUATION 15.

Finally, at block 718, the artificial neural network updates parameters of the artificial neural network based on an approximate derivative of a loss with respect to the activation signal. In one configuration, the parameters include weights and biases in a model of the artificial neural network. The parameters may be updated based on EQUATIONS 16 and 17.

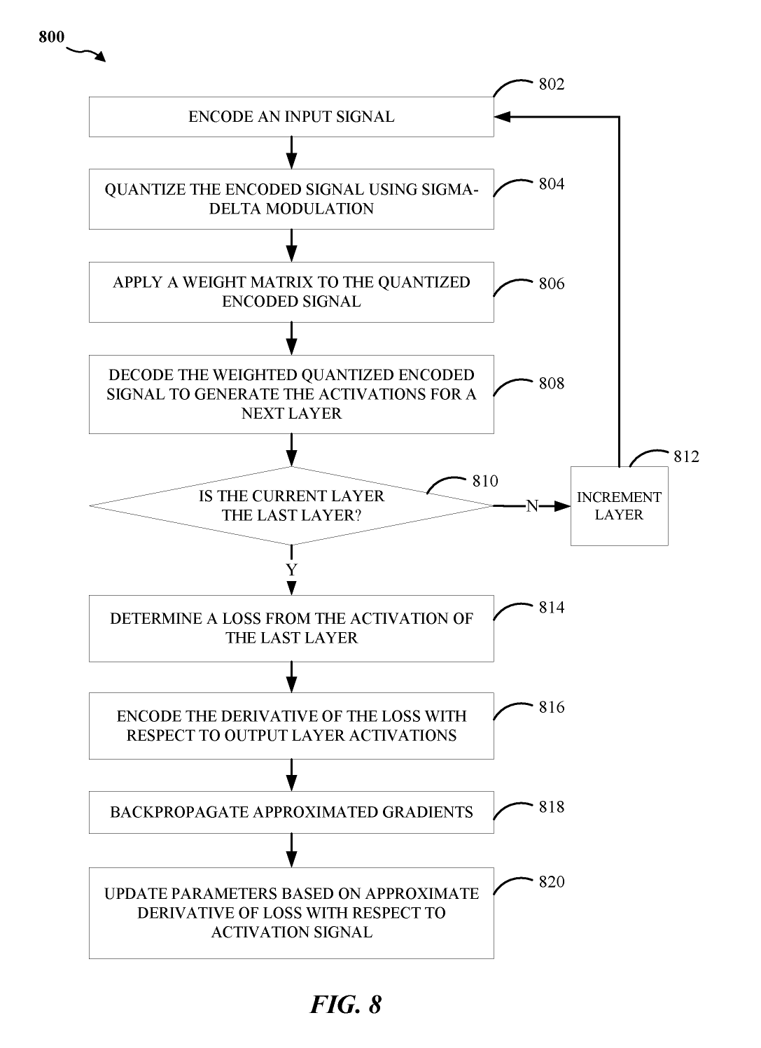

FIG. 8 illustrates a method 800 for processing temporally redundant data in an artificial neural network in accordance with aspects of the present disclosure. At block 802, the artificial neural network encodes an input signal received at an initial layer of the artificial neural network. The signal may be an activation signal and the signal may be encoded at each time step t as a combination of a current activation kₚ and change in action (e.g., rate of change in time) k_{d}. In one configuration, an initial signal xₜ (e.g., original signal) at a time step t is encoded with the encoding function (enc) of EQUATION 4 to obtain an encoded signal αₜ (see EQUATION 8).

At block 804, the artificial neural network quantizes the encoded signal into integer values (e.g., integer signal) using Sigma-Delta modulation. That is, in this configuration, Sigma-Delta modulation is applied to the encoded signal αₜ to create an integer signal sₜ, which can be used to approximately reconstruct the initial signal xₜ. The quantization may be performed by the quantization function Q of EQUATION 3. When the data is temporally redundant, the integer is a sparse integer signal comprised of mostly zeros with a few ones and negative ones. The sparse integer signal may be a sparse vector including the integer values.

At block 806, the artificial neural network applies a weight matrix to the quantized encoded signal. At block 808 the artificial neural network decodes a product of the weight matrix and the quantized encoded signal (e.g., weighted quantized encoded signal) to compute the activation signal. That is, the activation signal \hat{z}ₜ is approximated by decoding the product of the sparse integer signal sₜ (e.g., quantized signal) and a weight matrix wₜ. The process for computing the activation signal may be performed according to EQUATION 10. The weights of the weight matrix may comprise real values. Further, the weights of the weight matrix may also vary or change over time.

At block 810, the artificial neural network determines whether the current layer is the last layer (e.g., output layer) of the artificial neural network. If the current layer is not the last layer, the artificial neural network increments the current layer (e.g., moves to the subsequent layer) (block 812) and encodes the input signal of the incremented layer (block 802). In one configuration, the artificial neural network computes an activation signal of a neuron at each layer subsequent to the current layer to compute a full forward pass of the artificial neural network. That is, the artificial neural network repeats a process for computing an activation signal of a neuron for each layer of the neural network to compute a full forward pass of the neural network.

At block 810, if the current layer is the last layer (e.g., a full forward pass has been completed), the artificial neural network determines a loss from the activation of the last layer (block 814). At block 816, the artificial neural network encodes (enc) the derivative of the loss with respect to output layer activations. At block 818, the artificial neural network back propagates approximated gradients. That is, after completing the forward pass, a loss [symbol] is obtained after the last layer of the neural network. A derivative of the loss with respect to output layer activations loss is encoded and back propagated for all layers of the neural network. The process for back propagating approximated gradients may be performed according to EQUATION 15.

Finally, at block 820, the artificial neural network updates parameters of the artificial neural network based on an approximate derivative of a loss with respect to the activation signal. In one configuration, the parameters include weights and biases in a model of the artificial neural network. The parameters may be updated based on EQUATIONS 16 and 17.

In some aspects, methods 700 and 800 may be performed by the SOC 100 (FIG. 1) or the system 200 (FIG. 2). That is, each of the elements of method 700 may, for example, but without limitation, be performed by the SOC 100 or the system 200 or one or more processors (e.g., CPU 102 and local processing unit 202) and/or other components included therein.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer- readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of processing temporally redundant data in an artificial neural network (ANN), comprising:
encoding an input signal, received at an initial layer of the ANN, into an encoded signal comprising the input signal and a rate of change of the input signal;
quantizing the encoded signal into integer values;
computing an activation signal of a neuron in a next layer of the ANN based on the quantized encoded signal;
computing an activation signal of a neuron at each layer subsequent to the next layer to compute a full forward pass of the ANN, the activation signal of the neuron at each layer computed based on quantizing an encoded activation signal at each layer;
back propagating approximated gradients; and
updating parameters of the ANN based on an approximate derivative of a loss with respect to the activation signal.

2. The method of claim 1, further comprising quantizing the encoded signal using Sigma-Delta modulation.

3. The method of claim 1, further comprising encoding an activation signal received at each layer of the ANN.

4. The method of claim 1, in which the computing the activation signal comprises:
applying a weight matrix to the quantized encoded signal; and
decoding a product of the weight matrix and the quantized encoded signal.

5. The method of claim 4, in which weights of the weight matrix change over time.

6. The method of claim 1, in which the quantized encoded signal comprises a sparse vector including the integer values.

7. The method of claim 1, in which the parameters comprise weights and biases in a model of the ANN.

8. An apparatus for processing temporally redundant data in an artificial neural network (ANN), comprising:
means for encoding an input signal, received at an initial layer of the ANN, into an encoded signal comprising the input signal and a rate of change of the input signal;
means for quantizing the encoded signal into integer values;
means for computing an activation signal of a neuron in a next layer of the ANN based on the quantized encoded signal;
means for computing an activation signal of a neuron at each layer subsequent to the next layer to compute a full forward pass of the ANN, the activation signal of the neuron at each layer computed based on quantizing an encoded activation signal at each layer;
means for back propagating approximated gradients; and
means for updating parameters of the ANN based on an approximate derivative of a loss with respect to the activation signal.

9. The apparatus of claim 8, further comprising means for quantizing the encoded signal using Sigma-Delta modulation.

10. The apparatus of claim 8, further comprising means for encoding an activation signal received at each layer of the ANN.

11. The apparatus of claim 8, in which the means for computing the activation signal comprises:
means for applying a weight matrix to the quantized encoded signal; and
means for decoding a product of the weight matrix and the quantized encoded signal.

12. The apparatus of claim 11, in which weights of the weight matrix change over time.

13. The apparatus of claim 8, in which the quantized encoded signal comprises a sparse vector including the integer values.

14. The apparatus of claim 8, in which the parameters comprise weights and biases in a model of the ANN.

15. An artificial neural network (ANN) for processing temporally redundant data, comprising:
a memory; and
at least one processor coupled to the memory, the at least one processor configured:
to encode an input signal, received at an initial layer of the ANN, into an encoded signal comprising the input signal and a rate of change of the input signal;
to quantize the encoded signal into integer values;
to compute an activation signal of a neuron in a next layer of the ANN based on the quantized encoded signal;
to compute an activation signal of a neuron at each layer subsequent to the next layer to compute a full forward pass of the ANN, the activation signal of the neuron at each layer computed based on quantizing an encoded activation signal at each layer;
to back propagate approximated gradients; and
to update parameters of the ANN based on an approximate derivative of a loss with respect to the activation signal.

16. The ANN of claim 15, in which the at least one processor is further configured to quantize the encoded signal using Sigma-Delta modulation.

17. The ANN of claim 15, in which the at least one processor is further configured to encode an activation signal received at each layer of the ANN.

18. The ANN of claim 15, in which the at least one processor is further configured to compute the activation signal by:
applying a weight matrix to the quantized encoded signal; and
decoding a product of the weight matrix and the quantized encoded signal.

19. The ANN of claim 18, in which weights of the weight matrix change over time.

20. The ANN of claim 15, in which the quantized encoded signal comprises a sparse vector including the integer values.

21. The ANN of claim 15, in which the parameters comprise weights and biases in a model of the ANN.

22. A non-transitory computer-readable medium having program code recorded thereon for processing temporally redundant data in an artificial neural network (ANN), the program code executed by a processor and comprising:
program code to encode an input signal, received at an initial layer of the ANN, into an encoded signal comprising the input signal and a rate of change of the input signal;
program code to quantize the encoded signal into integer values;
program code to compute an activation signal of a neuron in a next layer of the ANN based on the quantized encoded signal;
program code to compute an activation signal of a neuron at each layer subsequent to the next layer to compute a full forward pass of the ANN, the activation signal of the neuron at each layer computed based on quantizing an encoded activation signal at each layer;
program code to back propagate approximated gradients; and
program code to update parameters of the ANN based on an approximate derivative of a loss with respect to the activation signal.

23. The non-transitory computer-readable medium of claim 22, in which the program code further comprises program code to quantize the encoded signal using Sigma-Delta modulation.

24. The non-transitory computer-readable medium of claim 22, in which the program code further comprises program code to encode an activation signal received at each layer of the ANN.

25. The non-transitory computer-readable medium of claim 22, in which the program code to compute the activation signal further comprises:
program code to apply a weight matrix to the quantized encoded signal; and
program code to decode a product of the weight matrix and the quantized encoded signal.

26. The non-transitory computer-readable medium of claim 25, in which weights of the weight matrix change over time.

27. The non-transitory computer-readable medium of claim 22, in which the quantized encoded signal comprises a sparse vector including the integer values.

28. The non-transitory computer-readable medium of claim 22, in which the parameters comprise weights and biases in a model of the ANN.
